(19) United States
(12) Patent Application Publication
(10) Pub. No.: US 2010/0245586 A1
(43) Pub. Date: Sep. 30, 2010

(54) PROJECTION DISPLAY APPARATUS

(75) Inventors: Tomoya TERAUCHI, Osaka (JP); Masutaka INOUE, Osaka (JP); Susumu TANASE, Osaka (JP); Yoshinao HIRANUMA, Osaka (JP); Takaaki ABE, Osaka (JP); Masahiro HARAGUCHI, Osaka (JP); Makoto MAEDA, Osaka (JP); Shinya MATSUMOTO, Osaka (JP); Azusa TAKEUCHI, Osaka (JP); Ryoko KUBO, Osaka (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi-shi (JP)

(21) Appl. No.: 12/716,597

(22) Filed: Mar. 3, 2010

(30) Foreign Application Priority Data
Mar. 24, 2009 (JP) 2009-072820
May 29, 2009 (JP) 2009-130566

(51) Int. Cl. H04N 5/33; H04N 5/222

(52) U.S. Cl. 348/164; 348/333.1; 348/E05.022; 348/E05.09

(57) ABSTRACT

A camera for capturing an object that will enter a projection space is attached to the casing of a projection display apparatus. The camera is installed at the position in which, when the camera faces the projection plane, at least one of the back direction and the side direction of the casing is included within the filed of view of the camera. For example, the cameras are installed on both side edges of the casing so as to face each other.

### CROSS REFERENCE TO RELATED APPLICATIONS

This application is based upon and claims the benefit of priority from the prior Japanese Patent Application No. 2009-072820, filed Mar. 24, 2009 and Japanese Patent Application No. 2009-130566, filed May 29, 2009, the entire contents of which are incorporated herein by reference.

### BACKGROUND OF THE INVENTION

1. Field of the Invention

The present invention relates to a projection display apparatus for projecting an image on a projection plane.

2. Description of the Related Art

Recently, the development of projectors in which lasers with large radiation energy are used as light sources has been under way. It is necessary to take sufficient measures for a person not to erroneously enter a projection space through which the light projected from such a projector passes. Accordingly, in order to detect an object that will enter the projection space, a technique of providing, on the front surface of the casing of a apparatus, a sensor for detecting a light from the direction of a screen, has been proposed.

On the other hand, the development of short focus projectors in which the installation distance up to a projection plane such as a screen can be made extremely small, has been in progress. For example, a type of the short focus projector has been put to practical use, in which a big-screen image can be projected on a wall, which is to be a projection plane, even when the projector is installed at the position almost in contact with the wall. In such a short focus projector, the projection distance can be made small, allowing for the space to be used effectively.

Because the aforementioned short focus projector is installed at a position close to a projection plane, the distance between the short focus projector and a viewer, who watches a projected image, projected on the projection plane, is likely to be small, and further it is difficult to isolate both from each other. If a viewer or a passerby erroneously approaches the short focus projector too closely when a laser with large radiation energy is used as a light source of the short focus projector, there is an increased possibility that a light of the level by which the human body is adversely affected may enter his/her eyes or strike his/her skins.

### SUMMARY OF THE INVENTION

A projection display apparatus according to an embodiment of the present invention is used for projecting an image on a projection plane and is provided with a camera for capturing an object that will enter a projection space, the camera being attached to the casing of the projection display apparatus. The camera is installed at the position, in which, when the camera faces the projection plane, at least one of the back direction and the side direction of the casing is included within the field of view of the camera.

It is noted that any combination of the aforementioned components or any manifestation of the present invention exchanged between methods, apparatuses, systems and so forth, is effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are views illustrating an installation example of a short throw distance type projection display apparatus, of which FIG. 1A is a view illustrating a projection plane and the projection display apparatus when seen from the front, and FIG. 1B is a view illustrating both, when seen from the top;

FIG. 2 is a view schematically illustrating the side cross section of the projection display apparatus illustrated in FIGS. 1A and 1B;

FIG. 3 is a view illustrating a structure example of an optical system of the projection display apparatus illustrated in FIGS. 1A and 1B;

FIG. 4 is a view illustrating an example in which a camera is installed on the casing of the projection display apparatus illustrated in FIGS. 1A and 1B;

FIG. 5 is a view illustrating an example in which two cameras (a first camera and a second camera) are installed on the casing of the projection display apparatus according to Embodiment 1, which is illustrated in FIGS. 1A and 1B;

FIG. 6 is a view illustrating an example in which two cameras (a first camera and a second camera) are installed on the casing of the projection display apparatus according to Embodiment 2, which is illustrated in FIGS. 1A and 1B;

FIG. 7 is a view illustrating an example in which two cameras (a first camera and a second camera) are installed on the casing of the projection display apparatus according to Embodiment 3, which is illustrated in FIGS. 1A and 1B;

FIG. 8 is a perspective view of a projection display apparatus on which two cameras (a first camera and a second camera) are installed, according to Example 1-1;

FIG. 9 is a perspective view of a projection display apparatus on which two cameras (a first camera and a second camera) are installed, according to Example 1-2;

FIG. 10 is a perspective view of a projection display apparatus on which two cameras (a first camera and a second camera) are installed, according to Example 1-3;

FIG. 11 is a perspective view of a projection display apparatus on which two cameras (a first camera and a second camera) are installed, according to Example 1-4;

FIG. 12A is a perspective view of a projection display apparatus on which two cameras (a first camera and a second camera) are installed, according to Example 2-1, and FIG. 12B is a top view of the projection display apparatus on which the two cameras are installed, according to Example 2-1;

FIG. 13A is a perspective view of a projection display apparatus on which two cameras (a first camera and a second camera) are installed, according to Example 2-2, and FIG. 13B is a top view of the projection display apparatus on which the two cameras are installed, according to Example 2-2;

FIG. 14A is a perspective view of a projection display apparatus on which two cameras (a first camera and a second camera) are installed, according to Example 2-3, and FIG. 14B is a top view of the projection display apparatus on which the two cameras are installed, according to Example 2-3;

FIG. 15A is a perspective view of a projection display apparatus on which a camera is installed, according to Example 3-1, and FIG. 15B is a top view of a projection display apparatus on which a camera is installed, according to Example 3-1;

FIG. 16A is a perspective view of a projection display apparatus on which two cameras (a first camera and a second camera) are installed, according to Example 3-2, and FIG. 16B is a side view of the projection display apparatus on which the two cameras are installed, according to Example 3-2;

FIG. 17A is a side cross-sectional view of a projection display apparatus on which two cameras (a first camera and a second camera) are installed, according to Example 4-1, and FIG. 17B is a top view of the projection display apparatus on which the two cameras are installed, according to Example 4-1;

FIG. 18A is a side cross-sectional view of a projection display apparatus on which two cameras (a first camera and a second camera) are installed, according to Example 4-2, and FIG. 18B is a top view of the projection display apparatus on which the two cameras are installed, according to Example 4-2;

FIG. 19A is a side cross-sectional view of a projection display apparatus on which two cameras (a first camera and a second camera) are installed, according to Example 4-3, and FIG. 19B is a top view of the projection display apparatus on which the two cameras are installed, according to Example 4-3;

FIG. 20A is a perspective view of a projection display apparatus according to Example 5-1, and FIG. 20B is a top view of the projection display apparatus according to Example 5-1;

FIG. 21A is a perspective view of a projection display apparatus according to Example 5-2, and FIG. 21B is a top view of the projection display apparatus according to Example 5-2;

FIG. 22 is a perspective view of a screen on which a camera is installed and a projection display apparatus, according to Example 6-1;

FIG. 23A is a perspective view of a screen on which two cameras (a first camera and a second camera) are installed and a projection display apparatus, according to Example 6-2, and FIG. 23B is a top view of the screen on which the two cameras are installed and the projection display apparatus, according to Example 6-2;

FIG. 24A is a perspective view of a screen on which two cameras (first camera and second camera) are installed and a projection display apparatus, according to Example 6-3, and FIG. 24B is a top view of the screen an which the two cameras are installed and the projection display apparatus, according to Example 6-3;

FIG. 25 is a perspective view of a screen on which a camera is installed and a projection display apparatus, according to Example 6-4;

FIG. 26 is a perspective view of a pole on which a camera is installed and a projection display apparatus, according to Example 7-1; and

FIG. 27 is a perspective view of a pole on which a camera is installed and a projection display apparatus, according to Example 7-2.

### DETAILED DESCRIPTION OF THE INVENTION

The invention will now be described by reference to the preferred embodiments. This does not intend to limit the scope of the present invention, but to exemplify the invention.

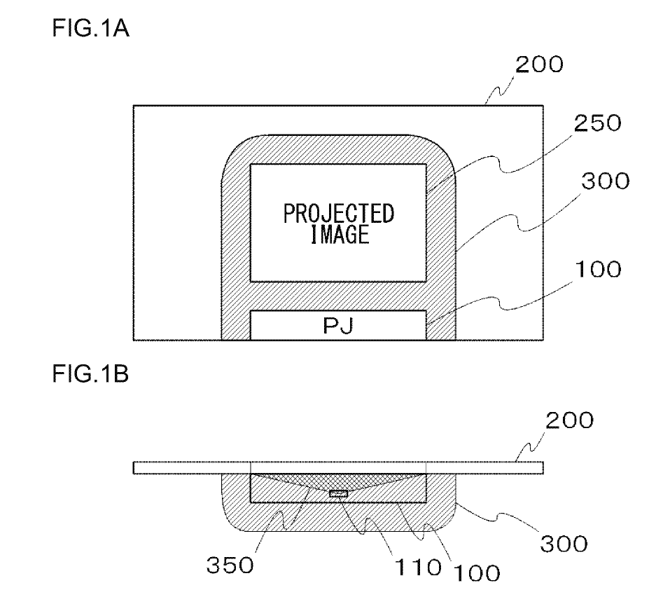

FIGS. 1A and 1B are views illustrating an installation example of a short throw distance type projection display 100. FIG. 1A is a view illustrating a projection plane 200 and the projection display 100, when seen from the front, whereas FIG. 1B is a view illustrating both, when seen from the top.

The casing of the projection display 100 illustrated in FIGS. 1A and 1B is structured to have a rectangular parallelepiped shape whose width is larger than the height or the depth thereof. FIGS. 1A and 1B illustrate an example in which the projection plane 200, made of a screen or a wall, etc., is in contact with the floor surface. The projection display 100 (which is denoted with PJ in FIG. 1A) is installed on the floor surface, and further, installed at the position where the front surface of the casing is substantially in contact with the projection plane 200. In the projection plane 200, a projection area 250 on which a projected image, which has been projected from the projection display 100, is to be projected is formed. A projection port 110 is provided on the upper surface of the casing of the projection display 100, and the light emitted from the projection port 110 is guided to the projection area 250.

The area of FIGS. 1A and 1B, drawn with diagonal lines, illustrates a detection area (which may also be considered as a monitored area) 300 in which an entering object is to be detected. Herein, the detection area 300 is set to the area including both the range between the projection space 350 through which the light emitted from the projection port 110 passes, the range within a certain distance (e.g., 1.0 m) from the projection space 350, and the range within a certain distance (e.g., 1.0 m) from the main body of the projection display 100.

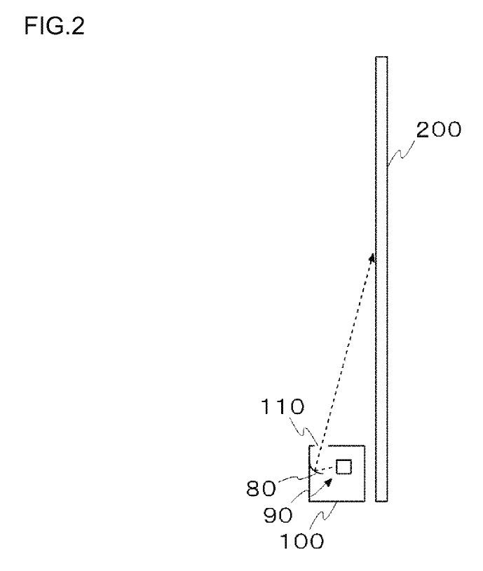

FIG. 2 is a view schematically illustrating the side cross section of the projection display 100 illustrated in the FIGS. 1A and 1B. An optical system 90 provided in the projection display 100 includes a reflective mirror 80 by which the light emitted from a projection lens, which will be described later, is reflected to be guided onto the projection plane 200 through the projection port 110.

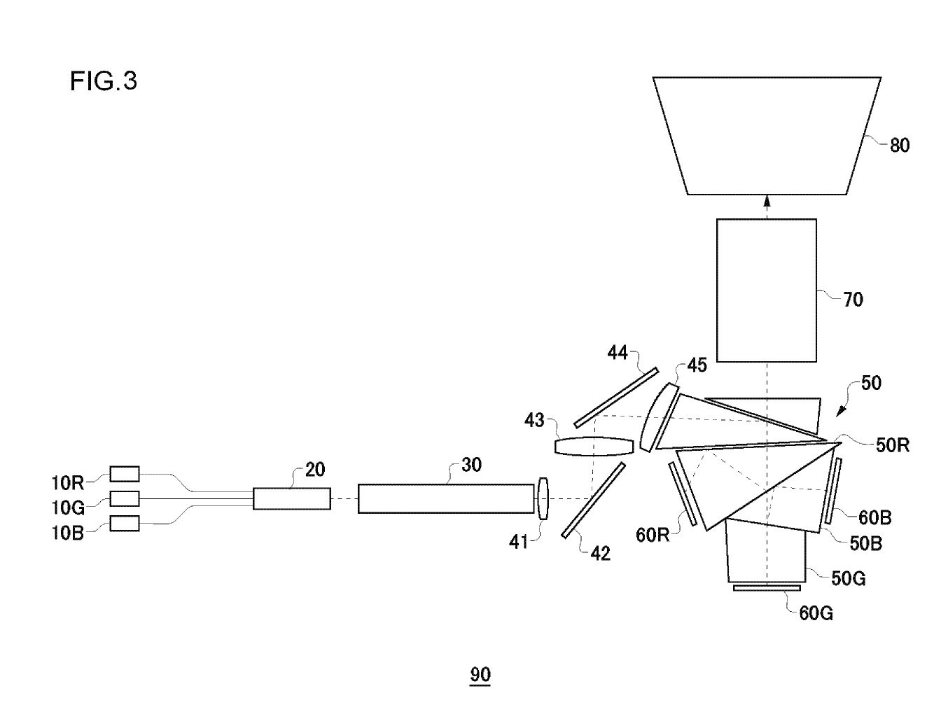

FIG. 3 is a structure example of the optical system 90 of the projection display 100 illustrated in FIGS. 1A and 1B. In this structure example, three primary color laser light sources (a red light source 10R, a green light source 10G, and a blue light source 10B) are provided. A plurality of the red light sources 10R, the green light source 10G, or the blue light sources 10B, may be provided. Each light source is connected to an optical fiber. The optical fibers, connected to each light source, are bundled with a fiber bundle 20, and the light emitted from the end of each optical fiber is incident on a color separation/synthesis prism 50 through, in this order, a rod integrator 30, a first relay lens 41, a first mirror 42, a second relay lens 43, a second mirror 44, and a third relay lens 45.

After incident on the color separation/synthesis prism 50, the light is separated into a red light, a green light, and a blue light, by a red prism 50R, a green prism 50G, and a blue prism 50B, of which the color separation/synthesis prism 50 is composed. The red light, the green light, and the blue light thus separated are incident on a red light modulator 60R, a green light modulator 60G, and a blue light modulator 60B, respectively. For example, a DMD (Digital Micro-mirror Device) can be used in the red light modulator 60R, the green light modulator 60G, or the blue light modulator 60B. The red light modulator 60R, the green light modulator 60G, and the blue light modulator 60B, respectively modulate the red light, the green light, and the blue light, which have been incident thereon, in accordance with image signals of each color, the image signals being set.

The light paths of the red light, the green light, and the blue light, which have been modulated by the red light modulator 60R, the green light modulator 60G, and the blue light modulator 60B, respectively, are integrated by the red prism 50R, the green prism 50G, and the blue prism 50B so that the light synthesized by each light is incident on the projection lens 70 from the color separation/synthesis prism 50.

The projection lens 70 widens the angle of the light, incident from the color separation/synthesis prism 50, to emit the light on the reflective mirror 80. The reflective mirror 80 further widens the angle of the light, incident from the projection lens 70, to guide the light to the projection plane 200 from the projection port 110 (see FIG. 2). An aspheric mirror may be used for the reflective mirror 80. The projection lens 70 and the reflective mirror 80 may be composed of an integrated hybrid projection optical system.

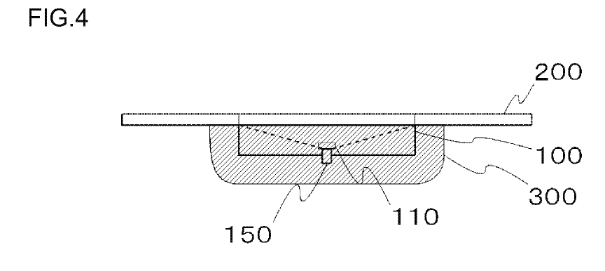

FIG. 4 is a view illustrating an example in which a camera 150 is installed on the casing of the projection display 100 illustrated in FIGS. 1A and 1B. Herein, the camera 150 for capturing an object that will enter the projection space 350 is provided on the upper surface of the casing of the projection display 100. More specifically, the camera 150 is provided at the central position in the width direction of the casing. The dashed lines in FIG. 4 indicate the field of view of the camera 150. Because the projection space 350 is included within the field of view of the camera 150 as illustrated by the dashed lines, a projected image, projected on the projection plane 200, and an object that will enter the projection space 350 can be captured by the camera 150. However, because the area other than the projection space 350 is not included within the field of view thereof, a person who have entered, for example, the detection area 300 in the side direction or the back direction of the casing, cannot be captured.

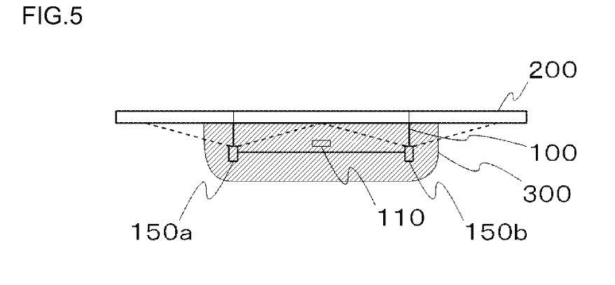

FIG. 5 is a view illustrating an example in which two cameras (a first camera 150a and a second camera 150b) are installed on the casing of the projection display 100 according to Embodiment 1, which is illustrated in FIGS. 1A and 1B. The projection display 100 emits light in an oblique direction from the projection port 110 provided on the upper surface of the casing. Herein, the light is emitted in the direction tilted at a predetermined angle from directly above toward the projection plane 200 such that the light is guided into the projection area 250 on the projection area 200 (see FIG. 1A). The first camera 150a is installed on the left end of the casing when the camera faces the projection plane 200. More specifically, the first camera 150a is installed in the upper left corner on the back side of the casing. The second camera 150b is installed on the right end of the casing. More specifically, the second camera 150b is installed in the upper right corner on the back side of the casing.

The first camera 150a and the second camera 150b are installed to face the projection plane 200. At least the left half of the aforementioned projected image and part of the casing in the left side direction are included within the field of view of the first camera 150a. On the other hand, at least the right half of the aforementioned projected image and part of the casing in the right side direction are included within the field of view of the second camera 150b. When combining the images captured by the first camera 150a and the second camera 150b, the whole of the aforementioned projected image can be included within the fields of view of both cameras. Accordingly, even an object that has entered the side direction of the casing can be captured by the first camera 150a and the second camera 150b within the range included within the fields of view of both cameras in addition that an image, projected on the projection plane 200, and an object that has entered the projection space 350 and its vicinity can be captured.

The images captured by the first camera 150a and the second camera 150b are analyzed by a non-illustrated image analyzer. The image analyzer can detect an entering object by applying the background subtraction method or the frame difference method to the captured image. When an entering object is detected, a safety precaution, such as interruption of the projection and issuance of an alarm, will be taken. The images captured by the first camera 150a and the second camera 150b can also be used for the geometric correction of a projected image in accordance with the distortion state of a screen.

As stated above, according to Embodiment 1, an object that has approached the side of the casing can be detected by installing two cameras on the casing of the projection display 100, allowing for the security to be further enhanced.

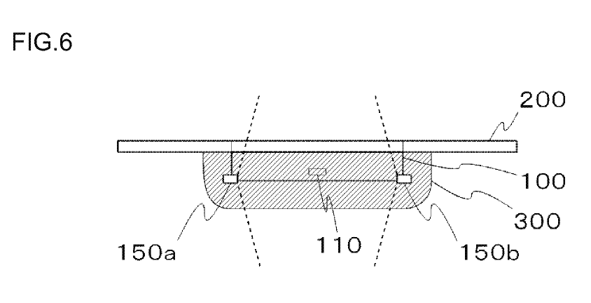

FIG. 6 is a view illustrating an example in which two cameras (a first camera 150a and a second camera 150b) are installed on the casing of the projection display 100 illustrated in FIGS. 1A and 1B, according to Embodiment 2. The first camera 150a and the second camera 150b are installed on both side edges of the casing of the projection display 100 so as to face each other. More specifically, the first camera 150a is installed in the upper left corner on the back side of the casing. On the other hand, the second camera 150b is installed in the upper right corner on the back side of the casing. Thereby, a larger area of the image, projected on the projection plane 200, can be included within the fields of view of both cameras.

In the example illustrated in FIG. 6, at least the right half of the aforementioned projected image, the right side direction of the casing, and at least the right half of the back direction of the casing are included within the field of view of the first camera 150a. On the other hand, at least the left half of the aforementioned projected image, the left side direction of the casing, and at least the left half of the back direction of the casing are included within the field of view of the second camera 150b. When combining the images captured by the first camera 150a and the second camera 150b, the whole of the aforementioned projected image can be included within the fields of view of both cameras.

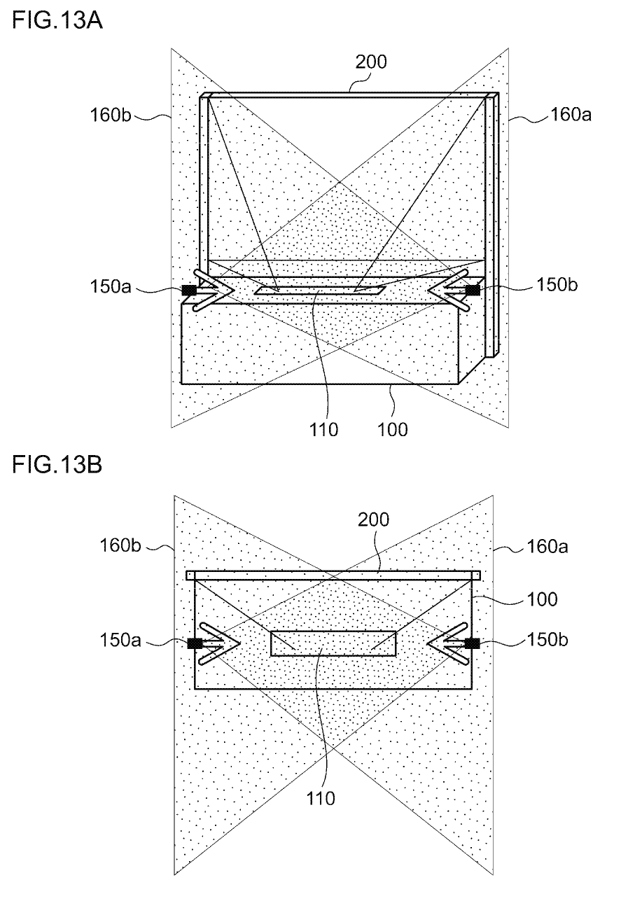

Accordingly, even an object that has entered both the side direction and the back direction of the casing can be captured by the first camera 150a and the second camera 150b in addition that an image, projected on the projection plane 200, and an object that has entered the projection space 350 (see FIG. 13) and its vicinity can be captured. That is, any object that will enter the detection area 300 can be captured.

As stated above, according to Embodiment 2, even an object that has approached the side and the back of the casing of the projection display 100 can be detected by installing two cameras on both side edges of the casing so as to face each other, allowing for the security to be further enhanced. Because the first camera 150a and the second camera 150b are in the relationship of monitoring each other, an object that is approaching the back of either the first camera 150a or the second camera 150b can be readily detected.

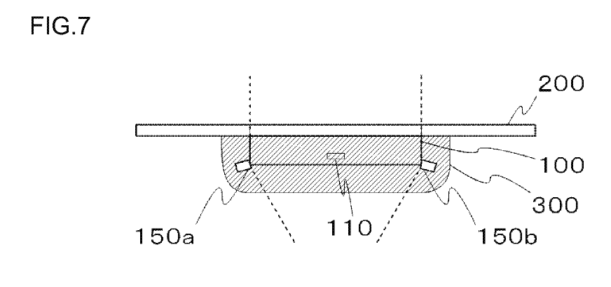

FIG. 7 is a view illustrating an example in which two cameras (a first camera 150a and a second camera 150b) are installed on the casing of the projection display 100 illustrated in FIGS. 1A and 1B, according to Embodiment 3. Although the first camera 150a and the second camera 150b are respectively installed at the positions described in Embodiment 2, the directions of both cameras are different from those in Embodiment 2. That is, the first camera 150a to be installed on the left side when the first camera 150a faces the projection plane 200, is installed after the direction of the first camera 150a is adjusted such that the left end of the field of view of the camera 150a corresponds to the left end of the image, projected on the projection plane 200, (for example, both left ends substantially match each other). The second camera 150b to be installed on the right side when the second camera 150b faces the projection plane 200, is installed after the direction of the second camera 150b is adjusted such that the right end of the field of view of the camera corresponds to the right end of the image, projected on the projection plane 200. That is, both directions of the first camera 150a and the second camera 150b are shifted by a predetermined angle toward the projection plane 200, respectively.

The whole of the aforementioned projected image, the right side direction of the casing, and at least part of the back direction of the casing are included within the field of view of the first camera 150a. On the other hand, the whole of the aforementioned projected image, the left side direction of the casing, and part of the back direction of the casing are included within the field of view of the second camera 150b.

Accordingly, even an object that has entered both the side direction and the back direction of the casing can be captured by the first camera 150a and the second camera 150b in addition that an image, projected on the projection plane 200, and an object that has entered the projection space 350 (see FIG. 1B) and its vicinity can be captured. That is, any object that will enter the detection area 300 can be captured.

As stated above, according to Embodiment 3, a similar effects as that in Embodiment 2 can be obtained. In addition to that, the process of synthesizing the images, captured by two cameras, can be omitted by having adjusted the directions of both cameras such that the whole of a projected image can be captured by each camera, allowing for the efforts for processing image signals to be reduced. On the other hand, in Embodiment 2, it is assumed that the images, captured by both cameras, are synthesized, and hence a small angular field of view can be accepted in comparison with Embodiment 3. Accordingly, a relatively inexpensive camera can be used in Embodiment 2.

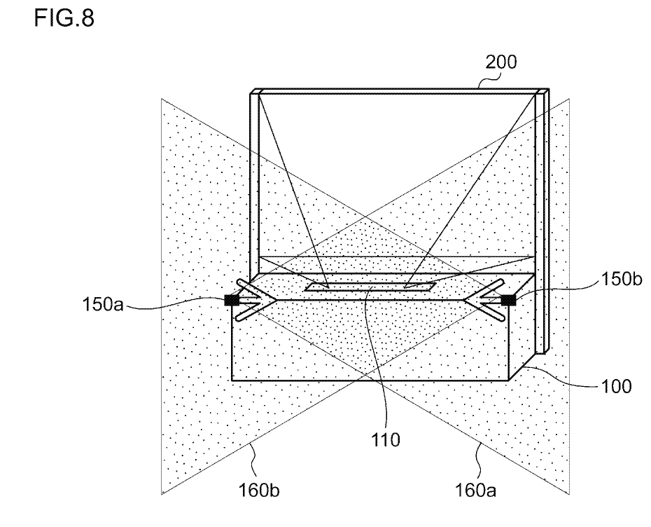

Hereinafter, the way to install a camera 150 will be described more specifically. FIG. 8 is a perspective view of a projection display 100 on which two cameras 150 (a first camera 150a and a second camera 150b) are installed, according to Example 1-1. When the side of the casing, which faces the projection plane 200, is defined as the front side, the first camera 150a is installed in the upper left corner on the back side of the projection display 100 installed on the floor whereas the second camera 150b is installed in the upper right corner on the back side of the casing.

In Example 1-1, the first camera 150a and the second camera 150b are installed to face each other as illustrated in FIG. 8. The capturing area 160a of the first camera 150a mainly includes the right side direction of the casing whereas the capturing area 160b of the second camera 150b mainly includes the left side direction thereof. Of course, the projection plane 200 and the back direction of the casing are included within the fields of view of both cameras. Such an installation way according to Example 1-1 is in particular effective for detecting an object that will enter from the side direction of the casing of the projection display 100.

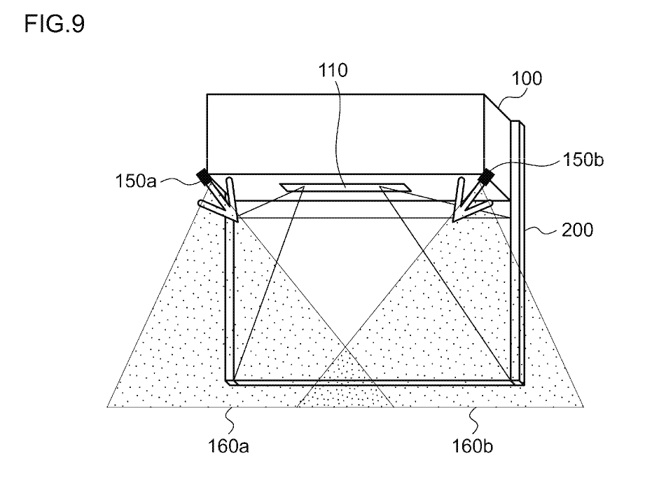

FIG. 9 is a perspective view of a projection display 100 on which two cameras 150 (a first camera 150a and a second camera 150b) are installed, according to Example 1-2. In Example 1-2, the projection display 100 is installed in a ceiling-suspended fashion without being installed on the floor. For example, the projection display 100 may be attached to the wall of a room like an air-conditioner, or may be attached to the corner formed between the ceiling and wall of a room. When the side of the casing, which faces the wall, is defined as the front side, the first camera 150a is installed in the lower left corner on the back side of the casing of the projection display 100, which is ceiling suspended, and the second camera 150b is installed in the lower right corner on the back side of the casing.

The first camera 150a and the second camera 150b are installed such that each camera is faced down. In FIG. 9, each camera is installed to be tilted at a predetermined angle toward the inside of the casing. The capturing area 160a of the first camera 150a mainly includes the near left side of the projection plane 200 (the front right side thereof) whereas the capturing area 160b of the second camera 150b mainly includes the near right side of the projection plane 200 (the front left side thereof). Such an installation way according to Example 1-2 is in particular effective for detecting an object that will enter the front of the projection plane 200.

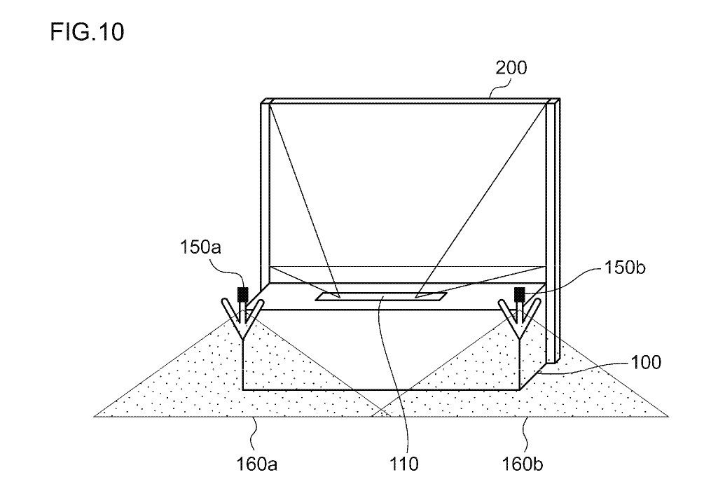

FIG. 10 is a perspective view of a projection display 100 on which two cameras 150 (a first camera 150a and a second camera 150b) are installed, according to Example 1-3. When the side of the casing, which faces the projection plane 200, is defined as the front side, the first camera 150a is installed in the upper left corner on the back side of the casing of the projection display 100 installed on the floor whereas the second camera 150b is installed in the upper right corner on the back side thereof.

In Example 1-3, the first camera 150a and the second camera 150b are installed such that each camera is faced down. The capturing area 160a of the first camera 150a mainly includes the lower left area on the back side of the casing whereas the capturing area 160b of the second camera 150b mainly includes the lower right area on the back side thereof. Such an installation way according to Example 1-3 is in particular effective for detecting an object that will enter the foot on the back side of the casing of the projection display 100.

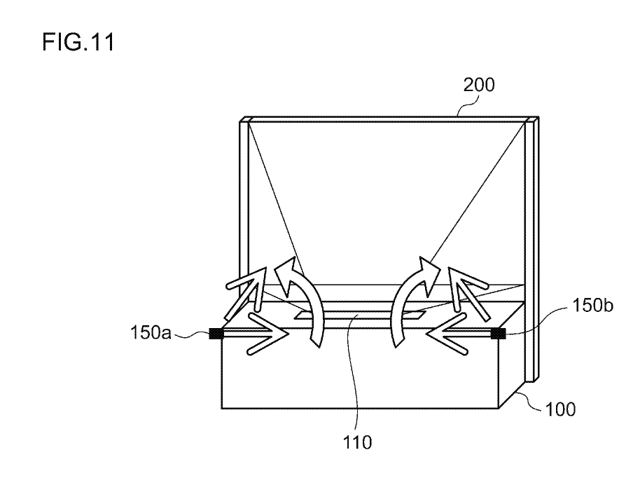

FIG. 11 is a perspective view of a projection display 100 on which two cameras 150 (a first camera 150a and a second camera 150b) are installed, according to Example 1-4. When the side of the casing, which faces the projection plane 200, is defined as the front side, the first camera 150a is installed in the upper left corner on the back side of the casing of the projection display 100 installed on the floor whereas the second camera 150b is installed in the upper right corner on the back side thereof.

In Example 1-4, the first camera 150a and the second camera 150b are respectively attached to the casing with respective rotatable supporting members (not illustrated). In FIG. 11, the first camera 150a is attached to the casing so as to be anticlockwise rotatable on the plane, on which the direction of the first camera 150a is perpendicular to the ground surface, with the direction of the first camera, in which the optical axis of the first camera 150a horizontally extends toward the second camera 150b, being the starting point. Or, the first camera 150a may be attached thereto so as to be anticlockwise rotatable on the plane that is tilted at a predetermined angle toward the projection plane 200 side from the aforementioned vertical plane. The second camera 150b is attached to the casing so as to be clockwise rotatable on the plane, on which the direction of the second camera 150b is perpendicular to the ground surface, with the direction of the second camera 150b, in which the optical axis of the second camera 150b horizontally extends toward the first camera 150a, being the starting point. Or, the second camera 150b may be attached thereto so as to be clockwise rotatable on the plane that is tilted at a predetermined angle toward the projection plane 200 side from the aforementioned vertical plane.

The directions of the first camera 150a and the second camera 150b may be adjusted in accordance with the installation conditions of the projection display 100. For example, when the projection display 100 is installed on the floor, the rotational angle of the direction of each camera from the initial position is set to zero or a small value, as illustrated in FIG. 8. When the projection display 100 is installed in a ceiling-suspended fashion, the rotational angle thereof is set to a large value, as illustrated in FIG. 9.

In addition, a user can arbitrarily adjust the rotational angle in accordance with the setting of the monitored area for monitoring an entering object. As stated above, in Example 1-4, the directions of the first camera 150a and the second camera 150b can be adjusted, and hence various installation conditions and various users' needs can be met. That is, the flexibility and versatility of the camera arrangement can be enhanced.

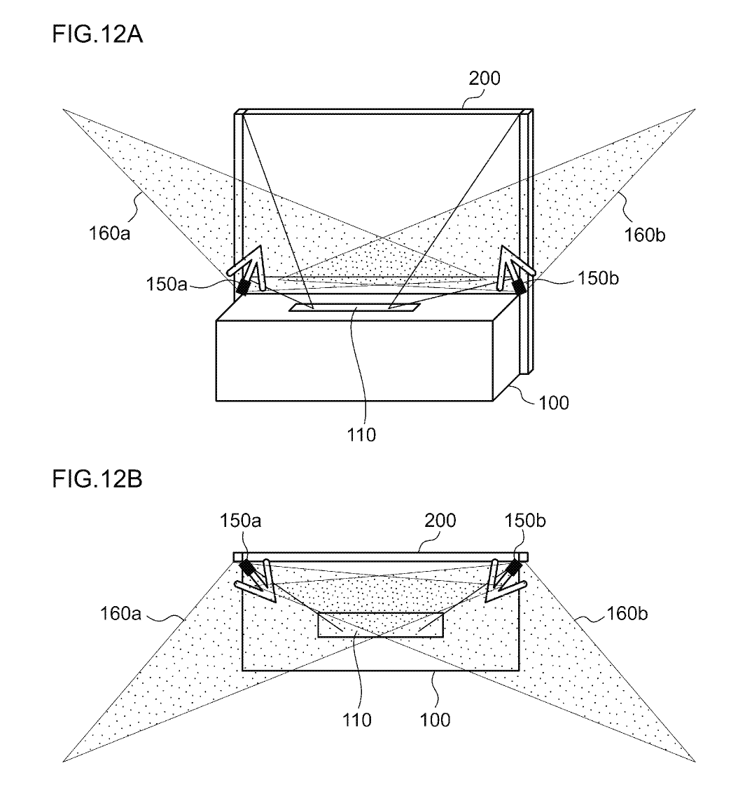

FIG. 12A is a perspective view of a projection display 100 on which two cameras (a first camera 150a and a second camera 150b) are installed, according to Example 2-1. FIG. 12B is a top view of the projection display 100 on which the two cameras 150 are installed, according to Example 2-1. When the side of the casing, which faces the projection plane 200, is defined as the front side, the first camera 150a is installed in the upper left corner on the front side of the casing of the projection display 100 installed on the floor whereas the second camera 150b is installed in the upper right corner on the front side of the casing.

In Example 2-1, the first camera 150a and the second camera 150b are respectively installed to face the back direction of the casing. In this case, both are installed to be tilted at a predetermined angle toward the inside of the casing. The capturing area 160a of the first camera 150a mainly includes the front left of the projection plane 200 whereas the capturing area 160b of the second camera 150b mainly includes the front right thereof. Such an installation way according to Example 2-1 is in particular effective for detecting an object that will enter the front of the projection plane 200.

FIG. 13A is a perspective view of a projection display 100 on which two cameras 150 (a first camera 150a and a second camera 150b) are installed, according to Example 2-2. FIG. 13B is a top view of the projection display 100 on which the two cameras 150 are installed, according to Example 2-2. The first camera 150a is installed at the central portion of the upper left side of the casing of the projection display 100 installed on the floor whereas the second camera 150b is installed at the central portion of the upper right side of the casing.

In Example 2-2, the first camera 150a and the second camera 150b are installed to face each other. The capturing area 160a of the first camera 150a mainly includes the right side direction of the casing whereas the capturing area 160b of the second camera 150b mainly includes the left side direction thereof. Of course, the projection plane 200 and the back direction of the casing are included within the fields of view of both cameras. Such an installation way according to Example 2-2 is in particular effective for detecting an object that will enter from the side direction of the casing of the projection display 100.

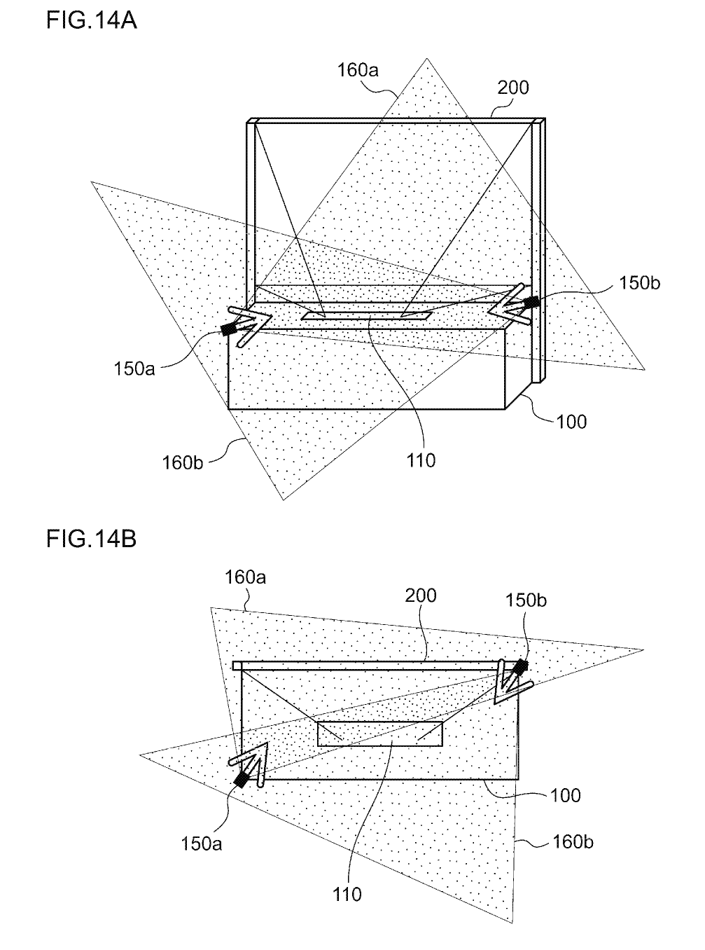

FIG. 14A is a perspective view of a projection display 100 on which two cameras 150 (a first camera 150a and a second camera 150b) are installed, according to Example 2-3. FIG. 14B is a top view of the projection display 100 on which the two cameras 150 are installed, according to Example 2-3. When the side of the casing, which faces the projection plane 200, is defined as the front side, the first camera 150a is installed in the upper left corner on the back side of the casing of the projection display 100 installed on the floor whereas the second camera 150b is installed in the upper right corner on the front side thereof.

In Example 2-3, the first camera 150a and the second camera 150b are installed on the diagonal line of the casing so as to face each other. The capturing area 160a of the first camera 150a mainly includes the projection plane 200 and its back whereas the capturing area 160b of the second camera 150b mainly includes the front of the projection plane 200. Such an installation way according to Example 2-3 is in particular effective for detecting an object that will enter the front and the back of the projection plane 200.

Contrary to the installation positions in FIGS. 14A and 14B, the first camera 150a may be installed in the upper left corner on the front side of the casing of the projection display 100 whereas the second camera 150b may be installed in the upper right corner on the back side thereof.

In Embodiment 2, a slide mechanism by which the first camera 150a is movable may be provided on the upper left side of the casing of the projection display 100. In addition, a slide mechanism by which the second camera 150b is movable may be provided on the upper right side of the casing. In this case, the flexibility and versatility of the camera arrangement can be enhanced. Further, the rotatable supporting member, described in Example 1-4, and this slide mechanism may be used in combination. In this case, the flexibility and versatility of the camera arrangement can be further enhanced.

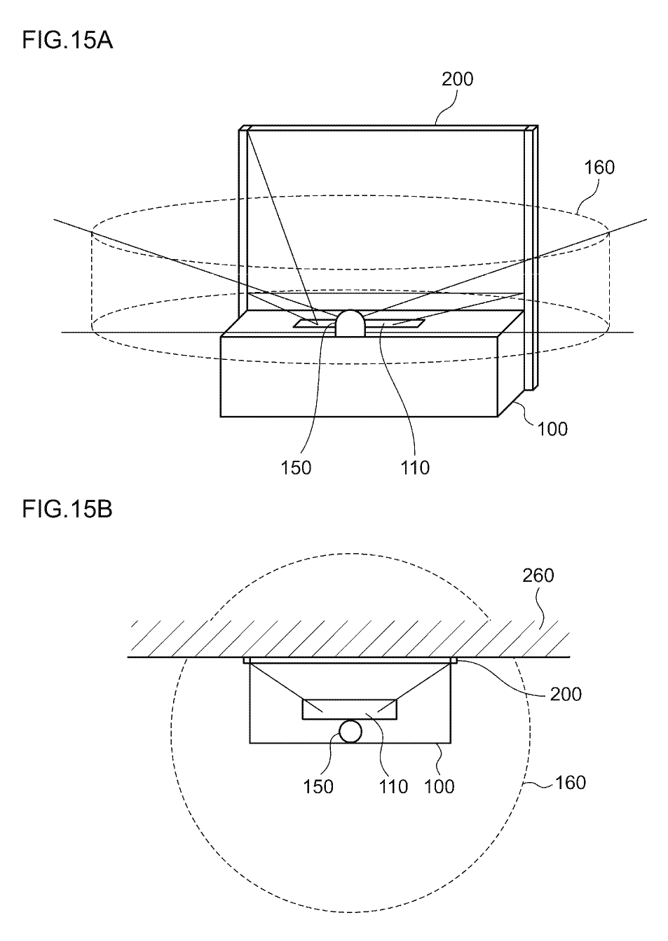

FIG. 15A is a perspective view of a projection display 100 on which a camera 150 is installed, according to Example 3-1. FIG. 15B is a top view of a projection display 100 on which a camera 150 is installed, according to Example 3-1. In Example 3-1, a panorama-image camera 150 is used. A screen, which is to be the projection plane 200, is installed in contact with the wall 260. The camera 150 is installed near a projection port 110 of the casing of the projection display 100 installed on the floor. Herein, when the side of the casing, which faces the projection plane 200, is defined as the front side, the camera 150 is installed, on the upper surface of the casing, in an area between the central portion in the longitudinal direction of the projection port 110 and the central portion of the side on the back side of the upper surface.

The capturing area 160 of the camera 150 includes the whole circumference in the horizontal direction relative to the upper surface of the casing. As stated above, according to Example 3-1, it is possible to monitor the whole circumference (360°) in the horizontal direction by using a panorama-image camera 150. In addition, the image that has been projected on the projection plane 200 can be captured by installing the camera 150 on the upper surface of the casing.

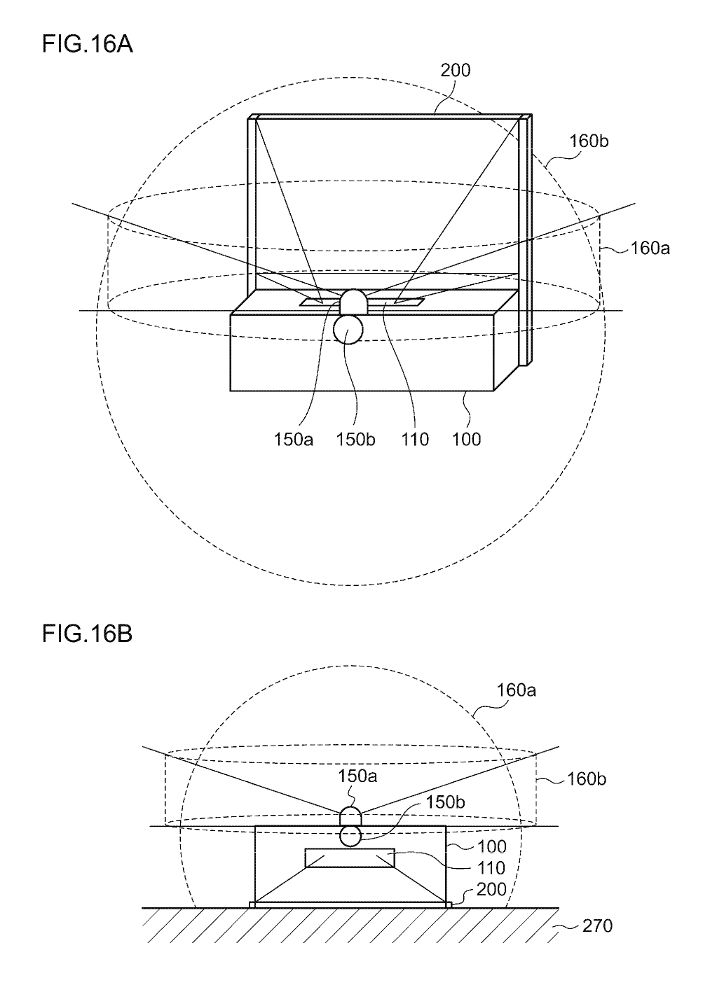

FIG. 16A is a perspective view of a projection display 100 on which two cameras 150 (a first camera 150a and a second camera 150b) are installed, according to Example 3-2. FIG. 16B is a side view of the projection display 100 on which the two cameras 150 are installed, according to Example 3-2. The first camera 150a and the second camera 150b are both panorama-image cameras. The first camera 150a is the same as the camera 150 described in Example 3-1, including the arrangement of the camera. In Example 3-2, the second camera 150b is used in addition to the first camera 150a.

When the side of the casing, which faces the projection plane 200, is defined as the front side, the second camera 150b is installed on the back surface of the casing of the projection display 100. Herein, the second camera 150b is installed near the central portion of the upper side of the back surface. The capturing area 160b of the second camera 150b includes the whole circumference in the horizontal direction relative to the back surface of the casing. That is, the capturing area 160b of the second camera 150b includes the whole circumference in the horizontal direction relative to the projection plane 200.

The examples in which the projection display 100 is installed on the floor such that an image is projected on the projection plane 200 such as a screen, which has been installed on the wall, have been described above. An image can also be projected on a projection plane 200 such as a screen, which has been installed on the floor, by installing the projection display 100 on the floor. Alternatively, the floor itself may be a projection plane 200. Or, the surface of a table, etc., may be a projection plane 200. In these cases, the surface of the casing of the projection display 100, which has been defined as the front side so far, is designed to face the floor. Thereby, the surface of the casing, on which the projection port 110 is provided, becomes the side surface, allowing for an image to be projected from the projection port 110 toward the projection plane 200 such as a screen, which has been installed on the floor.

FIG. 16B illustrates the state where an image is projected on a screen installed on the floor 270, which is to be the projection plane 200. In Example 3-2, when an image is projected on the projection plane 200 installed on the wall by the projection display 100 (hereinafter, referred to as the wall projection), an entering object is monitored by the first camera 150a. On the other hand, when an image is projected on the projection plane 200 installed on the floor 270 (hereinafter, referred to as the floor projection), an entering object is monitored by the second camera 150b.

In addition, a non-illustrated tilt sensor for detecting the tilt of the casing may be installed in the projection display 100. A non-illustrated controller can determine whether the wall projection or the floor projection is being carried out in accordance with a detection result of the tilt sensor. When the wall projection is being carried out, the controller makes the first camera 150a effective and the second camera 150b ineffective. On the other hand, when the floor projection is being carried out, the controller makes the first camera 150a ineffective and the second camera 150b effective.

As stated above, according to Example 3-2, it is possible to monitor the whole circumference (360°) in the horizontal direction by using two panorama-image cameras 150 when the wall projection or the floor projection is being carried out by the projection display 100. Further, two cameras 150 can be used selectively by using a tilt sensor, thereby reducing the power consumption in comparison with the case where the two cameras 150 are always used.

In Embodiment 3, a panorama-image detection apparatus, which can be made by combining a galvano-mirror or a polygon mirror with an image sensor, may be used instead of the panorama-image camera 150.

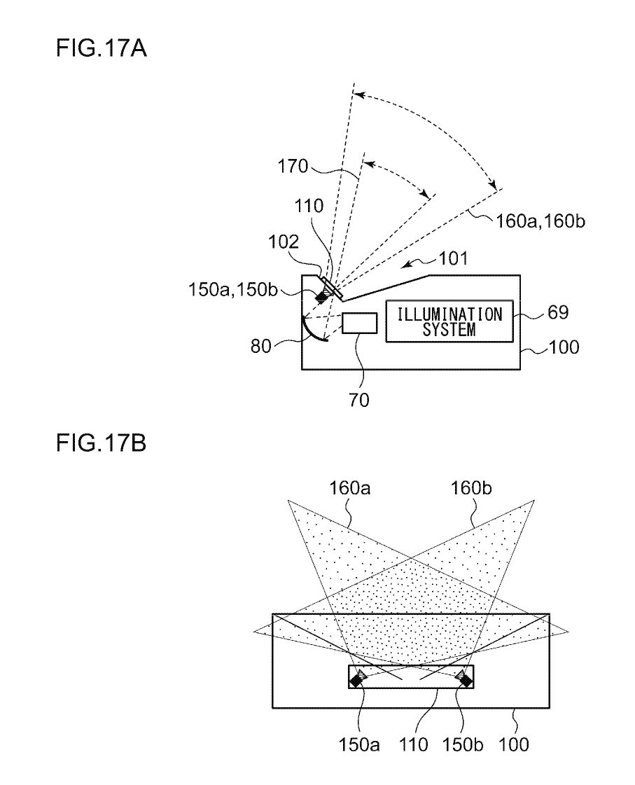

FIG. 17A is a side cross-sectional view of a projection display 100 on which two cameras 150 (a first camera 150a and a second camera 150b) are installed, according to Example 4-1. FIG. 17B is a top view of the projection display 100 on which the two cameras 150 are installed, according to Example 4-1. In Example 4-1, a V-shaped concavity 101 is provided on the upper surface of the projection display 100. A projection port 110 is formed on one slope 102 of the concavity 101.

As stated above, an illumination system 69, the projection lens 70, and the reflective mirror 80 are installed within the casing of the projection display 100. The light emitted from the illumination system 69 is incident on the reflective mirror 80 through the projection lens 70, and the reflective mirror 80 folds back the light so that the light is emitted outside from the projection port 110.

In Example 4-1, the first camera 150a and the second camera 150b are installed inside the projection port 110 formed on the aforementioned slope 102. Herein, the first camera 150a and the second camera 150b are respectively installed at both ends in the longitudinal direction of the projection port 110 so as to face the position where the projection plane 200 is located. The two cameras can be installed to have an angle approximating the projection angle. The capturing area 160a of the first camera 150a mainly includes the area on the right side of the projection plane 200 whereas the capturing area 160b of the second camera 150b mainly includes the area on the left side thereof. Both capturing areas 160a and 160b cross each other on the projection plane 200.

Such an installation way according to Example 4-1 is in particular effective for detecting an object that will enter the vicinity of the projection area 170. Further, because the first camera 150a and the second camera 150b are provided in the casing of the projection display 100, both cameras can be protected.

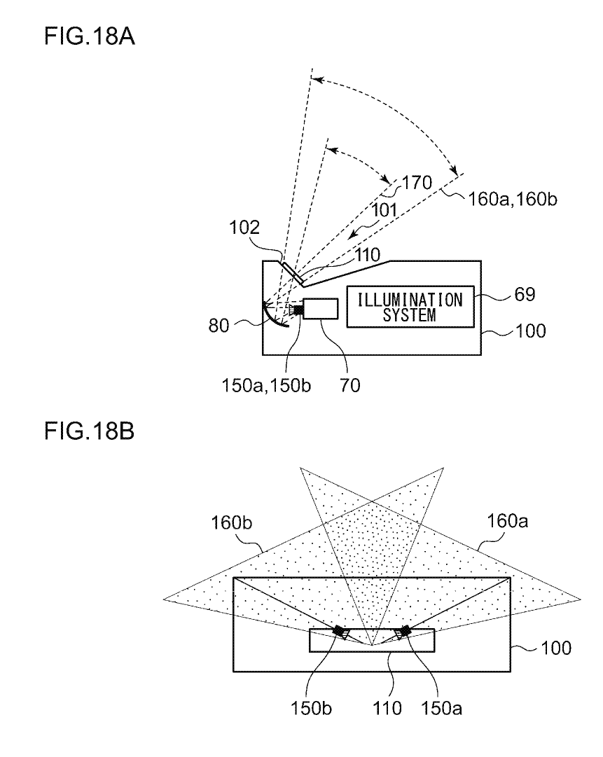

FIG. 18A is a side cross-sectional view of a projection display 100 on which two cameras 150 (a first camera 150a and a second camera 150b) are installed, according to Example 4-2. FIG. 18B is a top view of the projection display 100 on which the two cameras 150 are installed, according to Example 4-2. In Example 4-2, the first camera 150a and the second camera 150b are installed between the projection lens 70 and the reflective mirror 80.

The first camera 150a and the second camera 150b are respectively installed to face the reflective mirror 80. The first camera 150a is installed on the left side of the optical axis of the projected light, which has been emitted from the projection lens 70, whereas the second camera 150b is installed on the right side of the optical axis thereof. The capturing area 160a of the first camera 150a mainly includes the area on the left side of the projection plane 200 whereas the capturing area 160b of the second camera 150b mainly includes the area on the right side thereof. Both capturing areas 160a and 160b cross each other on the projection plane 200. The reflective mirror 80 reflects the projected light and also reflects the incident light, which has been incident from the capturing area 160.

Such an installation way according to Example 4-2 is in particular effective for detecting an object that will enter the vicinity of the projection area 170. Further, because the first camera 150a and the second camera 150b are formed in the casing of the projection display 100, both cameras can be protected.

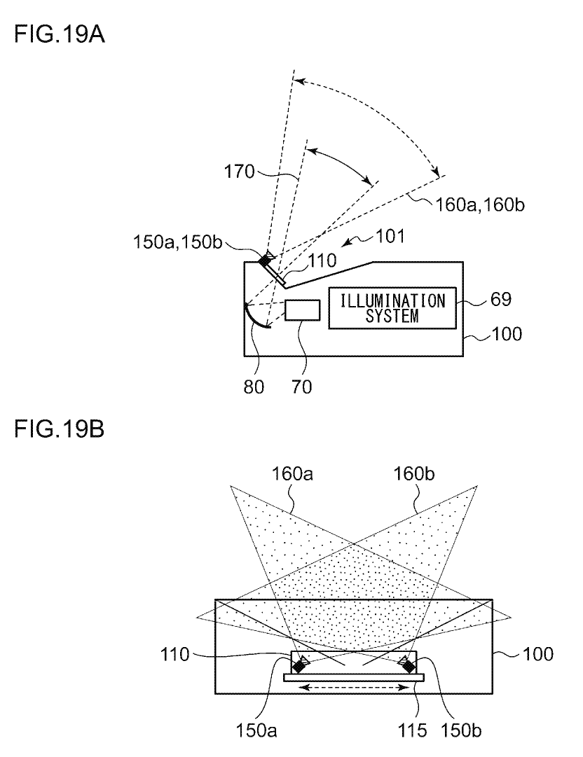

FIG. 19A is a side cross-sectional view of a projection display 100 on which two cameras 150 (a first camera 150a and a second camera 150b) are installed, according to Example 4-3. FIG. 19B is a top view of the projection display 100 on which the two cameras 150 are installed, according to Example 4-3. In Example 4-3, the first camera 150a and the second camera 150b are installed outside a projection port 110 formed on the aforementioned slope 102. Herein, the first camera 150a and the second camera 150b are respectively installed at both ends in the longitudinal direction of the projecting port 110 so as to face the position where the projection plane 200 is located. The two cameras can be installed to have an angle approximating the projection angle. The capturing area 160a of the first camera 150a mainly includes the area on the right side of the projection plane 200 whereas the capturing area 160b of the second camera 150b mainly includes the area on the left side thereof. Both capturing areas 160a and lab cross each other on the projection plane 200.

A slide mechanism 115 may be installed on the side in the longitudinal direction of the projection port 110 (herein, the side on the back side). In this case, the first camera 150a and the second camera 150b are installed in the slide mechanism 115, thereby each of which is movable on the slide mechanism 115.

Such an installation way according to Example 4-3 is in particular effective for detecting an abject that will enter the vicinity of the projection area 170. Further, the flexibility and versatility of the camera arrangement can be enhanced by installing the slide mechanism 115 in the vicinity of the projection port 110. In Example 4-3, three or more of the cameras 150 may be used.

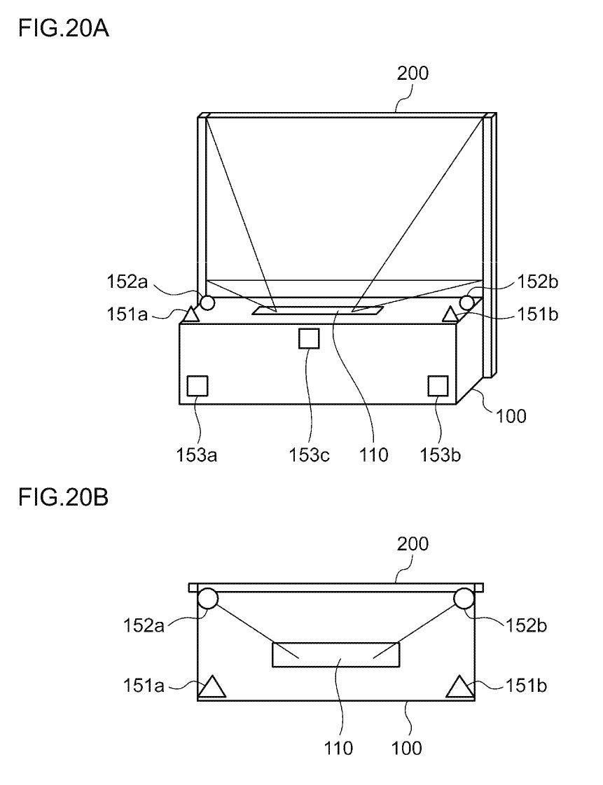

FIG. 20A is a perspective view of a projection display 100 according to Example 5-1. FIG. 20B is a top view of the projection display 100 according to Example 5-1. Hereinafter, the projection that has been described in Example 1-2, in which an image is projected on the projection plane 200 installed on the wall by the projection display 100, which has been installed in a ceiling-suspended fashion, is referred to as the ceiling suspension projection.

When the side of the casing, which faces the projection plane 200, is defined as the front side, a first mounting member 151a for the wall projection is installed in the left corner on the back side of the upper surface of the casing of the projection display 100, and a second mounting member 151b for the wall projection is installed in the right corner on the back side of the upper surface thereof, and a first mounting member 152a for the ceiling suspension projection is installed in the left corner on the front side of the upper surface thereof, and a second mounting member 152b for the ceiling suspension projection is installed in the right corner on the front side of the upper surface thereof.

A first mounting member 153a for the floor projection is installed in the left corner on the bottom side of the back surface of the casing of the projection display 100, and a second mounting member 153b for the floor projection is installed in the right corner on the bottom side of the back surface thereof, and a third mounting member 153c for the floor projection is installed at the central portion of the side toward the upper surface of the back surface thereof.

When a user intends to carry out the wall projection by the projection display 100, the first camera 150a is attached to the first mounting member 151a for the wall projection, and the second camera 150b is attached to the second mounting member 151b for the wall projection. When a user intends to carry out the ceiling suspension projection by the projection display 100, the first camera 150a is attached to the first mounting member 152a for the ceiling suspension projection, and the second camera 150b is attached to the second mounting member 152b for the ceiling suspension projection. When a user intends to carry out the floor projection by the projection display 100, the first camera 150a is attached to the first mounting member 153a for the floor projection, and the second camera 150b is attached to the second mounting member 151b for the floor projection, and the third camera is attached to the third mounting member 153c for the floor projection.

Each of the first camera 150a, the second camera 150b, and the third camera can transmit a captured image to a non-illustrated controller through cable or wireless communication. As stated above, according to Example 5-1, a camera can be arranged at an optimal position in accordance with the projection style. Further, because a camera is removable from the casing, the number of cameras to be prepared for can be reduced. In the example of Example 5-1, if cameras are attached in a fixed manner, seven cameras are required; however, three cameras are sufficient by designing so that the cameras are attached in a removable manner.

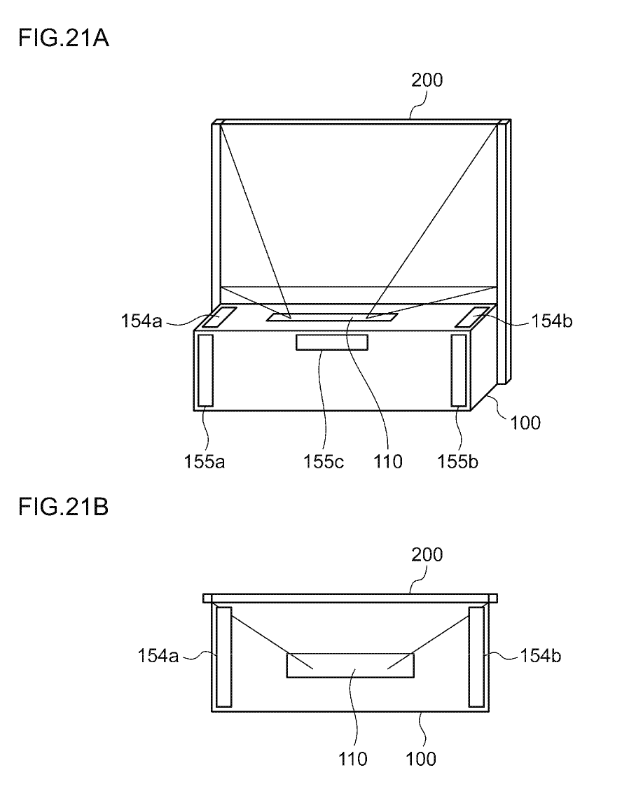

FIG. 21A is a perspective view of a projection display 100 according to Example 5-2. FIG. 21B is a top view of the projection display 100 according to Example 5-2. A first slide mechanism of upper surface 154a is installed on the left side of the upper surface of the casing of the projection display 100 according to Example 5-2, and a second slide mechanism of upper surface 154b is installed on the right side of the upper surface thereof. When the side of the casing, which faces the projection plane 200, is defined as the front side, a first slide mechanism of back surface 155a is installed on the left side of the back surface of the casing of the projection display 100, and a second slide mechanism of back surface 155b is installed on the right side of the back surface thereof, and a third slide mechanism of back surface 155c is installed at the central portion of the side on the upper surface side of the back surface thereof.

When a user intends to carry out the wall projection or the ceiling suspension projection by the projection display 100, the first camera 150a is attached to the slide mechanism of upper surface 154a, and the second camera 150b is attached to the second slide mechanism of upper surface 154b. Thereby, each camera can be fixed to an optimal position by arbitrarily moving the camera on the corresponding slide mechanism. In addition, when a user intends to carry out the floor projection by the projection display 100, the first camera 150a is attached to the first slide mechanism of back surface 155a, and the second camera 150b is attached to the second slide, mechanism of back surface 155b, and the third camera is attached to the third slide mechanism of back surface 155c. Thereby, each camera can be fixed to an optimal position by arbitrarily moving the camera on the corresponding slide mechanism.

Each of the first camera 150a, the second camera 150b, and the third camera can transmit a captured image to a non-illustrated controller through cable or wireless communication. In Example 5-2, because the movable range of each camera is made large, it is preferable that an image captured by each camera is projected and displayed on the projection plane 200 when each camera is installed. In this case, it is preferable that the brightness of the projected image is suppressed in order to sufficiently ensure the security. The brightness thereof can be suppressed by, for example, limiting the number of the laser light sources to be used among a plurality of laser light sources, or by reducing the signal value.

When a captured image is to be projected on the projection plane 200, the image may be projected into a small size. The projection into a small size helps to insure the security. Further, by projecting an image into a small size, images captured by a plurality of cameras can be simultaneously displayed on the projection plane 200. Images captured by a plurality cameras may be switched and displayed in accordance with a user's switching operation.

As stated above, according to Example 5-2, a camera can be located at an optimal position in accordance with the projection style. Further, because a camera is removable from the casing, the number of the cameras to be prepared for can be reduced. In addition, finer position adjustment is possible in comparison with Example 5-1.

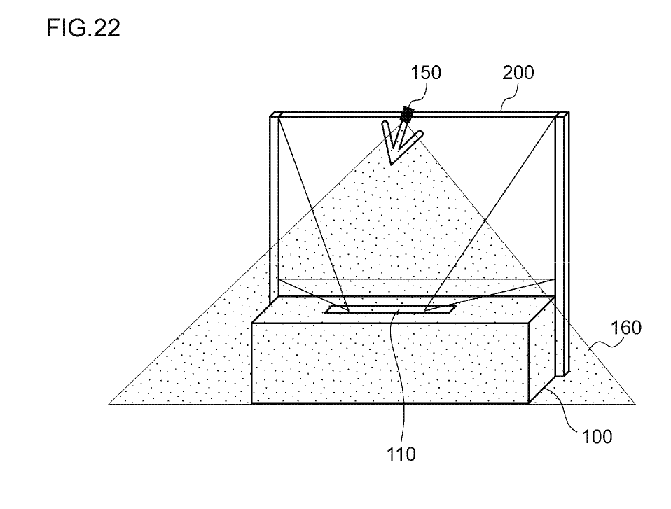

FIG. 22 is a perspective view of a screen and a projection display 100 on which a camera 150 is installed, according to Example 6-1. The camera 150 is installed at the central position of the upper side of a screen, which is to be the projection plane 200. The camera 150 is installed to be faced down at a predetermined angle. The capturing area 160 of the camera 150 mainly includes the area in front of the screen including the casing of the projection display 100, the area being close to the screen.

As stated above, such an installation way according to Example 6-1 is in particular effective for detecting an object that will enter the area in front of the screen. Further, by installing the camera 150 on the upper side of the screen, an image can be captured so as to look down from above. Thereby, a large area can be monitored by a single camera 150. Alternatively, the camera 150 may be designed to be movable on a slide mechanism by installing the slide mechanism on the upper side of the screen.

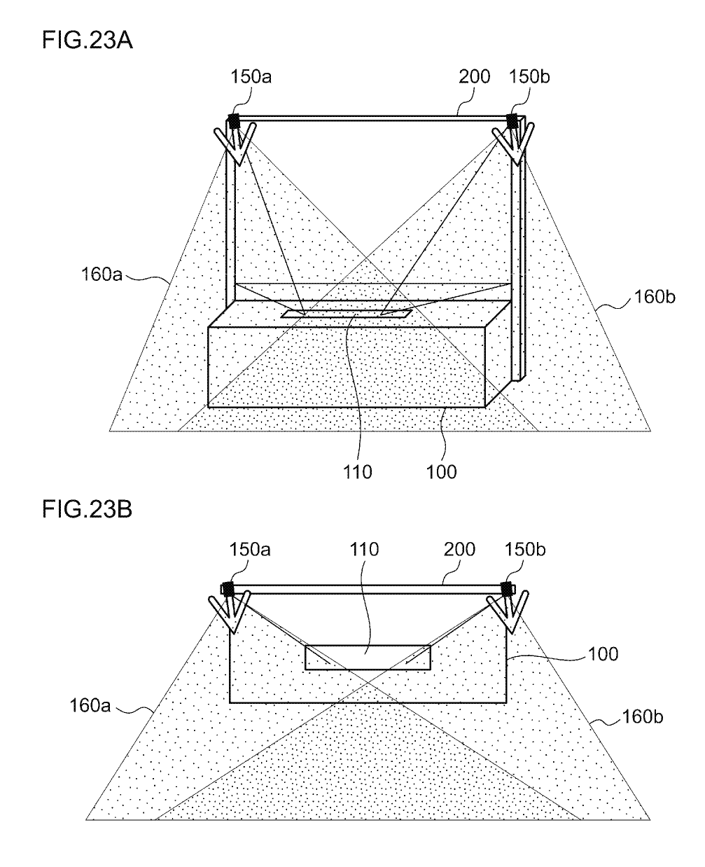

FIG. 23A is a perspective view of a screen on which two cameras 150 (a first camera 150a and a second camera 150b) are installed and a projection display 100, according to Example 6-2. FIG. 23B is a top view of the screen on which the two cameras 150 and the projection display 100, according to Example 6-2. When the surface of the screen on which an image is displayed is defined as the front side, the first camera 150a is installed in the upper right corner of the screen whereas the second camera 150b is installed in the upper left corner thereof.

Each of the first camera 150a and the second camera 150b is installed to be faced down at a predetermined angle. Further, each of the first camera 150a and the second camera 150b is installed to be tilted at a predetermined angle toward the inside of the screen.

The capturing area 160a of the first camera 150a mainly includes the area on the right side in front of the screen including the casing of the projection display 100, the area being close to the screen. On the other hand, the capturing area 160b of the second camera 150b mainly includes the area on the left side in front of the screen, the area being close to the screen. When the first camera 150a and the second camera 150b are installed to further tilted toward the inside of the screen, the capturing area 160a of the first camera 150a mainly includes the area on the left side in front of the screen including the casing of the projection display 100, the area being close to the screen. On the other hand, the capturing area 160b of the second camera 150b mainly includes the area on the right side in front of the screen, the area being close to the screen. That is, the capturing area 160a of the first camera 150a and the capturing area 160b of the second camera 150b are in the relationship of both capturing areas crossing each other. In addition, both the capturing area 160a of the first camera 150a and the capturing area 160b of the second camera 150b may be set so as to include the center of the area in front of the screen by adjusting the tilts of both cameras 150a and 150b.

Such an installation way according to Example 6-2 is in particular effective for detecting an object that will enter the area in front of the screen. In addition, the distance to the entering object can be estimated by using the captured image of the area in which the capturing area 160a of the first camera 150a and the capturing area 160b of the second camera 150b are superimposed one on another. The control is possible in accordance with the estimated distance.

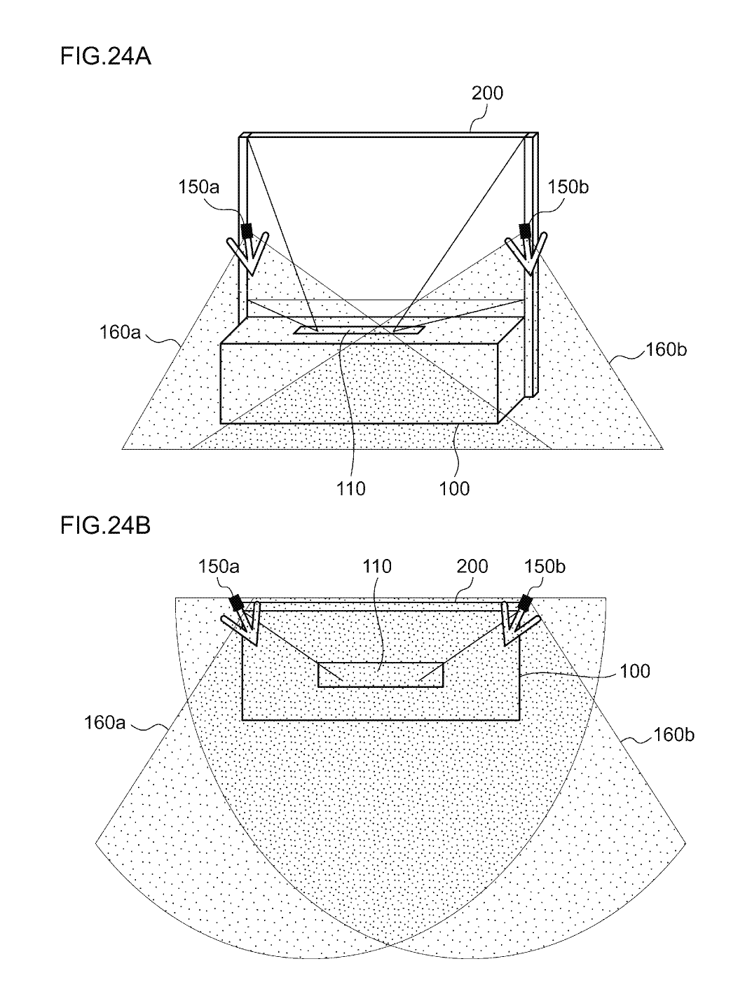

FIG. 24A is a perspective view of a screen on which two cameras 150 (a first camera 150a and a second camera 150b) and a projection display 100, according to Example 6-3. FIG. 24B is a top view of the screen on which the two cameras 150 are installed and the projection display 100, according to Example 6-3. When the surface of the screen on which an image is displayed is defined as the front side, the first camera 150a is installed at the central portion of the right side of the screen whereas the second camera 150b is installed at the central portion of the left side thereof.

Each of the first camera 150a and the second camera 150b is installed to be faced down at a predetermined angle. In addition, each of both cameras 150a and 150b is installed to be tilted at a predetermined angle toward the inside of the screen.

The capturing area 160a of the first camera 150a mainly include the area on the left side in front of the screen including the casing of the projection display 100, the area being close to the screen. On the other hand, the capturing area 160b of the second camera 150b mainly includes the area on the right side in front of the screen, the area being close to the screen. In Example 6-3, the casing of the projection display 100 and its vicinity can be monitored from a closer range in comparison with Example 6-2.

Such an installation way according to Example 6-3 is in particular effective for detecting an object that will enter the area in front of the screen. Alternatively, a slide mechanism may be provided on the right side of the screen such that the first camera 150a is designed to be movable on the slide mechanism. Or, a slide mechanism may be provided on the left side of the screen such that the second camera 150b is deigned to be movable on the slide mechanism. Thereby, the height of each of the first camera 150a and the second camera 150b can be adjusted.

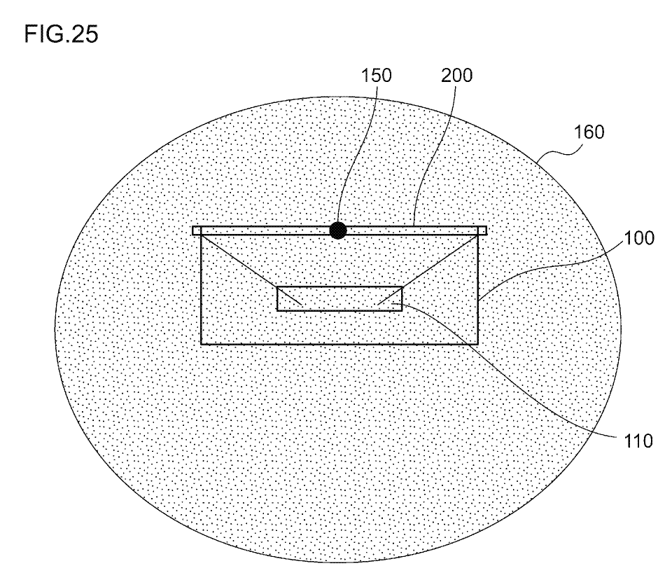

FIG. 25 is a perspective view of a screen on which a camera 150 is installed and a projection display 100, according to Example 6-4. The camera 150 is installed at the central portion of the upper side of the screen, which is to be the projection plane 200. Herein, a panorama-image camera 150 is used. The capturing area 160 of the camera 150 is the whole circumference in the vertical direction relative to the screen. As stated above, according to Example 6-4, it is possible to monitor the area around the screen (360°) in the horizontal direction by installing a panorama-image camera 150 on the upper side of the screen. An object that will enter the space behind the screen can be detected.

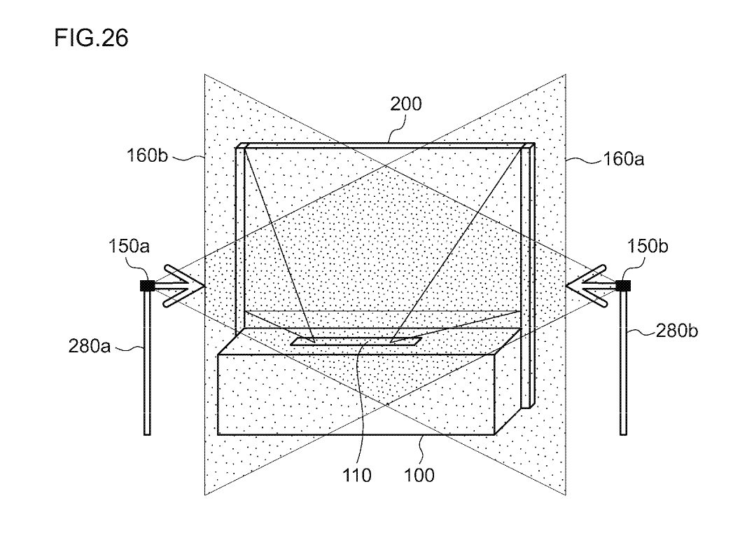

FIG. 26 is a perspective view of two poles 280 (a first pole 280a and a second pole 280b) on which two cameras 150 (a first camera 150a and a second camera 150b) are installed and a projection display 100, according to Example 7-1. The first pole 280a is installed on the left side of the casing of the projection display 100 so as to be spaced apart by a predetermined gap from the casing. The second pole 280b is installed on the right side of the casing thereof so as to be spaced apart by a predetermined gap from the casing. The first camera 150a is installed at the tip of the first pole 280a whereas the second camera 150b is installed at the tip of the second pole 280b. The first pole 280a and the second pole 280b may be ones for entry prevention.

The first camera 150a and the second camera 150b are installed to face each other. The capturing area 160a of the first camera 150a mainly includes the area in the right side direction of the casing of the projection display 100 whereas the capturing area 160b of the second camera 150b mainly includes the area in the left side direction of the casing thereof. Of course, the projection plane 200 and the back direction of the casing are within the fields of view of both cameras.

Such installation way according to Example 7-1 is in particular effective for detecting an object that will enter from the side direction of the casing of the projection display 100. In addition, because the cameras are not installed on the main body of the projection display 100 or the screen but installed at positions remote from the projection display 100, a larger area can be monitored. For example, in the installation way according to Example 7-1, both sides of the casing can be monitored in comparison with the installation way according to Example 1-1. As stated above, the whole of the projection display 100 can be looked down.

When a camera is attached to the pole for entry prevention, the security measures is implemented by the monitoring system based on the images captured by the camera in addition to that people are physically suppressed so as not to approach the projection display 100 by the pole itself. That is, the double security measures are to be implemented. Further, because a camera is not installed on the casing of the projection display 100, the aesthetic property of the projection display 100 is not spoiled. Moreover, views are less apt to pay too much attention to the camera.

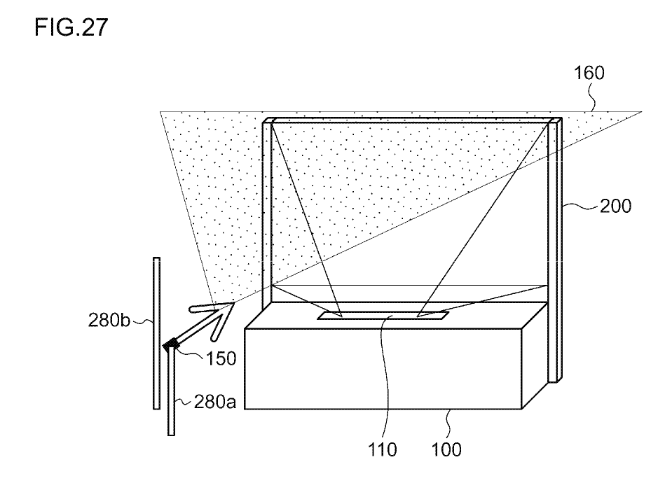

FIG. 27 is a perspective view of poles 280 on which a camera 150 is installed and a projection display 100, according to Example 7-2. In Example 7-1, the first pole 280a and the second pole 280b are installed on the diagonal line of the projection display 100, which is sandwiched by both poles. In Example 7-2, however, the poles 280 are installed at an arbitrary position around the projection display 100. The first pole 280a is installed at the position in the left diagonal direction on the back side of the casing of the projection display 100 so as to be spaced apart by a predetermined gap from the casing whereas the second pole 280b is installed near the first pole 280a.

In FIG. 27, the camera 150 is installed at the tip of the first pole 280a so as to face the projection plane 200. The capturing area 160 of the camera 150 includes the whole projection plane 200. The setting way according to Example 7-2 is suitable for the case where the projection display 100 is installed by being embedded in the stage. In this case, it is preferable that the camera 150 is installed on the pole 280, which has been installed in the stage or in the ground near the stage. Such an installation way according to Example 7-2 is in particular effective for detecting an object that will enter the front of the projection plane 200. Further, because the camera is not installed on the main body of the projection display 100 or the screen but installed at a position remote from the projection display 100, a larger area can be monitored even with a camera.

Although FIGS. 26 and 27 illustrate the examples in which a camera is installed on a pole, it should not be limited to a pole but a camera may be installed on any structure, which has been installed around the projection display 100. For example, when the projection display 100 is installed within a tower, a camera can be installed at any position in the tower. When the projection display 100 is installed within a show window, a camera can be installed on the window surface or the ceiling.

The present invention has been described above based on some embodiments. These embodiments are intended solely for the purpose of illustration, and it should be understood by those skilled in the art that various modifications are possible in combining those various components and various processing and those modifications also fall in the scope of the present invention.

In the aforementioned embodiments, a camera is used in order to detect an object that will enter a projection space, however, an infrared sensor may be used instead of the camera or in addition to the camera. The infrared sensor is installed at the position where, when the infrared sensor faces the projection plane 200, at least one of the back direction and the side direction of the casing of the projection display 100 is included within the detection range of the infrared sensor. In this case, it is necessary to install a light source by which an infrared ray (more specifically, a near-infrared ray) is emitted toward at least one of the side direction and the back direction of the casing in addition to the direction toward the projection plane 200, on, for example, the casing of the projection display 100. The infrared sensor detects the returned light of the infrared ray that has been emitted from the light source.

In the aforementioned embodiments, an ordinary camera is used in order to detect an object that will enter the projection space, however, an infrared camera may be used instead of the camera or in addition to the camera. The infrared camera is installed at a position in which, when the infrared camera faces the projection plane 200, at lest one of the back direction and the side direction of the casing of the projection display 100 is included within the field of view of the infrared camera. The infrared camera detects the infrared ray emitted from an entering object.

What is claimed is:

1. A projection display apparatus for projecting an image on a projection plane, comprising:
a camera configured to capture an object that will enter a projection space, the camera being attached to the casing of the projection display apparatus, wherein the camera is installed at the position in which, when observes the projection plane, at least one of the back direction and the side direction of the casing is included within the field of view of the camera.

2. The projection display apparatus according to claim 1, wherein two of the cameras are installed on the casing, and wherein the two cameras are installed on both side edges of the casing so as to face each other.

3. The projection display apparatus according to claim 1 configured to emit light in an oblique direction from a projection port provided on the upper surface of the casing, wherein cameras are installed on the left end and the right end of the casing, respectively, when the cameras face the projection plane.

4. The projection display apparatus according to claim 2, wherein, of the two cameras installed on the casing, the camera to be installed on the left side when the camera faces the projection plane, is installed such that the direction of the camera is adjusted to ensure that the left end of the field of view of the camera corresponds to the left end of the image, projected on the projection plane, and wherein the camera to be installed on the right end when the camera faces the projection plane, is installed such that the direction of the camera is adjusted to ensure that the right end of the field of view of the camera corresponds to the right end of the image, projected on the projection plane.

5. The projection display apparatus according to claim 3, wherein, of the two cameras installed on the casing, the camera to be installed on the left side when the camera faces the projection plane, is installed such that the direction of the camera is adjusted to ensure that the left end of the field of view of the camera corresponds to the left end of the image, projected on the projection plane, and wherein the camera to be installed on the right end when the camera faces the projection plane, is installed such that the direction of the camera is adjusted to ensure that the right end of the field of view of the camera corresponds to the right end of the image, projected on the projection plane.

6. A projection display apparatus for projecting an image on a projection plane, comprising:
an infrared sensor configured to detect an object that will enter a projection space, the infrared sensor being attached to the casing of the projection display apparatus, wherein the infrared sensor is installed at the position in which, when the infrared sensor faces the projection plane, at least one of the back direction and the side direction of the casing is included within the field of view of the infrared sensor.
